(19) United States
(12) Patent Application Publication
(10) Pub. No.: US 2026/0010786 A1
(43) Pub. Date: Jan. 8, 2026

(54) SLICE-BASED METHODS FOR EDGE CASE DETECTION IN MACHINE LEARNING MODELS

(71) Applicant: Robert Bosch GmbH, Stuttgart (DE)

(72) Inventors: Jorge Henrique Piazentin Ono, Sunnyvale, CA (US); Wenbin He, Sunnyvale, CA (US); Arvind Kumar Shekar, Weissach im Tal (DE); Liang Gou, San Jose, CA (US); Liu Ren, Saratoga, CA (US)

(21) Appl. No.: 18/765,897

(22) Filed: Jul. 8, 2024

(51) Int. Cl. G06N 3/08

(52) U.S. Cl. CPC G06N 3/08

(57) ABSTRACT

Methods for a machine-learning network that provide efficient, scalable, and granular analyses during validation of a machine learning model are disclosed. Validation of models depends upon many factors, including the real-world application of the model, the type of model being trained, and the types of data samples it is being trained on. In order to provide relevant edge case information to users that pertains to their specific model, data slice finding techniques may be used to identify subsets of the dataset that are particularly problematic. By limiting a length of the slice description that the algorithm searches and by configuring the algorithm to target specific types of errors, users are provided with a more granular analysis that then allows them to determine how or if they need to retrain the model.

### TECHNICAL FIELD

The present disclosure relates to techniques for validation and edge case detection of a machine learning model.

### BACKGROUND

Machine Learning (ML) has been used in a variety of critical applications, including autonomous driving, medical imaging, industrial fire detection, and credit scoring. Such applications need to be thoroughly evaluated before deployment in order to assess model capabilities and limitations. Unforeseen model mistakes may cause serious consequences in the real world: for example, a false sense of security in ML models may cause safety issues in driver assistance and industrial systems, misdiagnoses in medical analysis or treatment analysis, and biases against individuals and groups.

MLOps (Machine Learning Operations) engineers for product-quality model development may need a system that has identified that the evaluation of critical ML models and may be usually conducted beyond the aggregated level (e.g., a single performance metric). Instead, it may be beneficial to thoroughly evaluate model performance on carefully specified usage scenarios or conditions to meet important ML product requirements. Based on this analysis, experts can then take actions to both attempt to make the model more robust to various conditions and make customers aware of model limitations in certain conditions, aiding in the development of mitigating measures. However, determining how to parse through such large datasets and detect relevant patterns within the data samples remains a challenge.

### SUMMARY

Data slice finding is a valuable technique for assessing the performance of machine learning models. By identifying subsets of data for which a model fails to perform well, this approach can provide key insights into areas for model improvement that could not be previously discovered with traditional machine learning evaluation metrics. Data slice finding techniques are particularly useful for validating critical applications, where they can help to verify models perform consistently under different scenarios. However, prior methods of data slice finding succumbed to at least the following major limitations. First, they are not scalable when dealing with many metadata features. Second, they do not provide a nuanced or granular understanding of different error types in the model, instead producing data slices that aggregate all error types together. And third, they may result in a large number of data slices, making it difficult for experts to read them and understand the model's problems. To address these issues, the present disclosure provides efficient and customized data slice finding techniques that allow for data slice finding to be scalable by combining frequent pattern mining together with specially selected heuristics. Such techniques are highly efficient, and significantly reduce the running time required for error analysis. Furthermore, the framework described herein allows for a more granular analysis of error types, empowering users and machine learning experts to better understand the specific limitations of the model, while also offering novel metrics for guiding the user on the data slice analysis process, thus providing valuable tools for machine learning practitioners seeking to improve the performance of their models.

### BRIEF DESCRIPTION OF THE DRAWINGS

FIG. 1 illustrates a system for training a neural network, according to some embodiments.

FIG. 2 illustrates a computer-implemented method for training and utilizing a neural network, according to some embodiments.

FIG. 3 illustrates an iterative flow diagram for validation and edge case detection of a machine learning model, according to some embodiments.

FIG. 4 illustrates another iterative flow diagram for validation and edge case detection of a machine learning model, according to some embodiments.

FIG. 5 illustrates a flow diagram for identifying slices using data samples and attributes of a validation dataset, according to some embodiments.

FIG. 6A illustrates a listing of some of the identified slices for a given hair color classification model and the corresponding performance metric values for those slices, according to some embodiments.

FIG. 6B illustrates another listing of some of the identified slices for the given hair color classification model introduced in FIG. 6A, wherein the identified slices have been organized by a relative risk ratio defined by false negative errors.

FIG. 6C illustrates yet another listing of some of the identified slices for the given hair color classification model introduced in FIG. 6A, wherein the identified slices have been organized by a relative risk ratio defined by false positive errors.

FIG. 7 illustrates a graphic for the given hair color classification model introduced in FIG. 6A that demonstrates an approximate amount of time that is saved when applying an attribute length constraint during validation of a machine learning model, according to some embodiments.

FIG. 8 depicts a schematic diagram of an interaction between a computer-controlled machine and a control system, according to some embodiments.

FIG. 9 depicts a schematic diagram of the control system of FIG. 8 configured to control a vehicle, which may be a partially autonomous vehicle, a fully autonomous vehicle, a partially autonomous robot, or a fully autonomous robot, according to some embodiments.

FIG. 10 depicts a schematic diagram of the control system of FIG. 8 configured to control a manufacturing machine, such as a punch cutter, a cutter, or a gun drill, of a manufacturing system, such as part of a production line, according to some embodiments.

FIG. 11 depicts a schematic diagram of the control system of FIG. 8 configured to control a power tool, such as a power drill or driver, that has an at least partially autonomous mode, according to some embodiments.

FIG. 12 depicts a schematic diagram of the control system of FIG. 8 configured to control an automated personal assistant, according to some embodiments.

FIG. 13 depicts a schematic diagram of the control system of FIG. 8 configured to control a monitoring system, such as a control access system or a surveillance system, according to some embodiments.

FIG. 14 depicts a schematic diagram of the control system of FIG. 8 configured to control an imaging system, for example an MRI apparatus, x-ray imaging apparatus, or ultrasonic apparatus, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

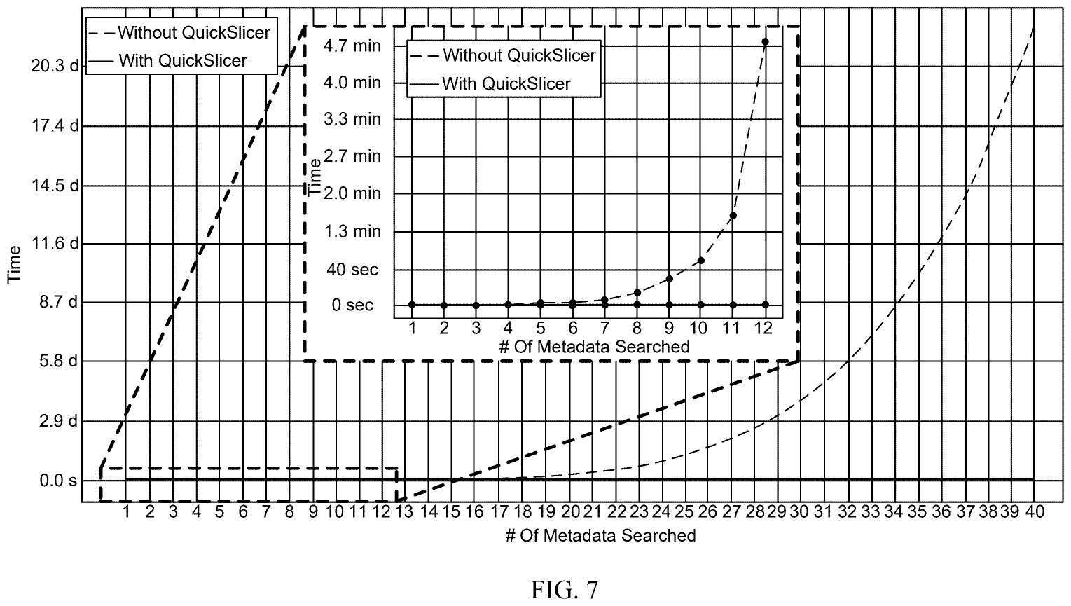

Machine learning models have become increasingly important in critical applications, such as autonomous driving, medical diagnosis, and credit scoring, where consistent and accurate performance is crucial. To ensure such performance, it is important to evaluate these models under different conditions and combination of conditions. For example, for an autonomous driving model (see also FIG. 9 and corresponding description herein), evaluation criteria may include varying weather, lighting, and clutter conditions in order to ensure consistent performance under different scenarios. In another example, decision making systems are thoroughly evaluated to prevent discrimination against minorities. Given the large number of conditions that need to be tested, and the amount of data within the various training datasets that enable the model to be evaluated under the variety of conditions, manually evaluating these models would be a time-consuming task, and would therefore potentially limit the size of datasets that are considered and/or not be able to keep pace with the changing environments, conditions, and other evaluation criteria that computer vision models are in need of being exposed to. Thus, methods for incorporating Data Slice Finding, such as those described herein, are effective and efficient techniques that may be used to evaluate machine learning models effectively. In some embodiments, methods for identifying slices and/or other subsets of a training or validation dataset allows for efficient edge case detection in ways that are customized to the specific type of machine learning model that is being evaluated. Data Slice Finding identifies specific data slices or subsets for which the model might fail, which may be referred to herein as edge cases and/or outliers, and enables a more comprehensive analysis of the model's strengths and weaknesses, enhancing the overall understanding of its performance.

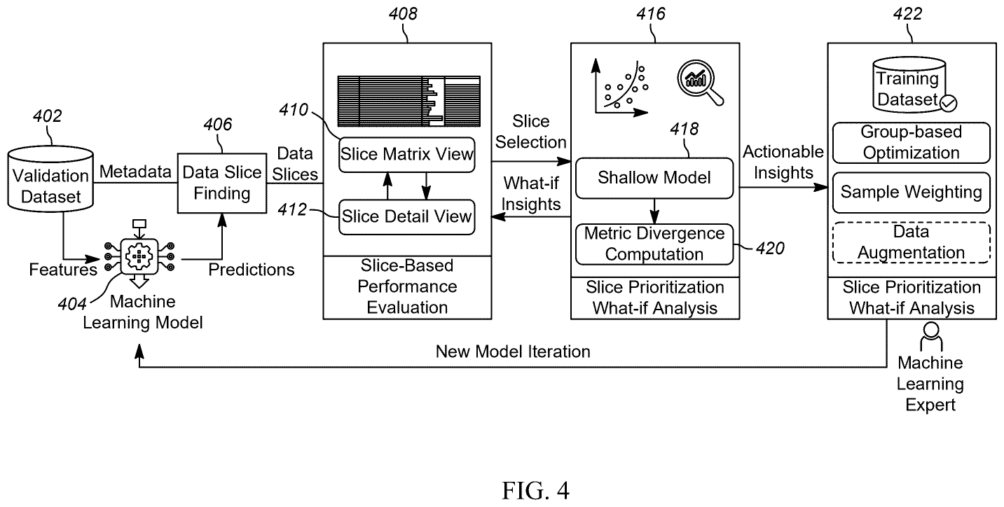

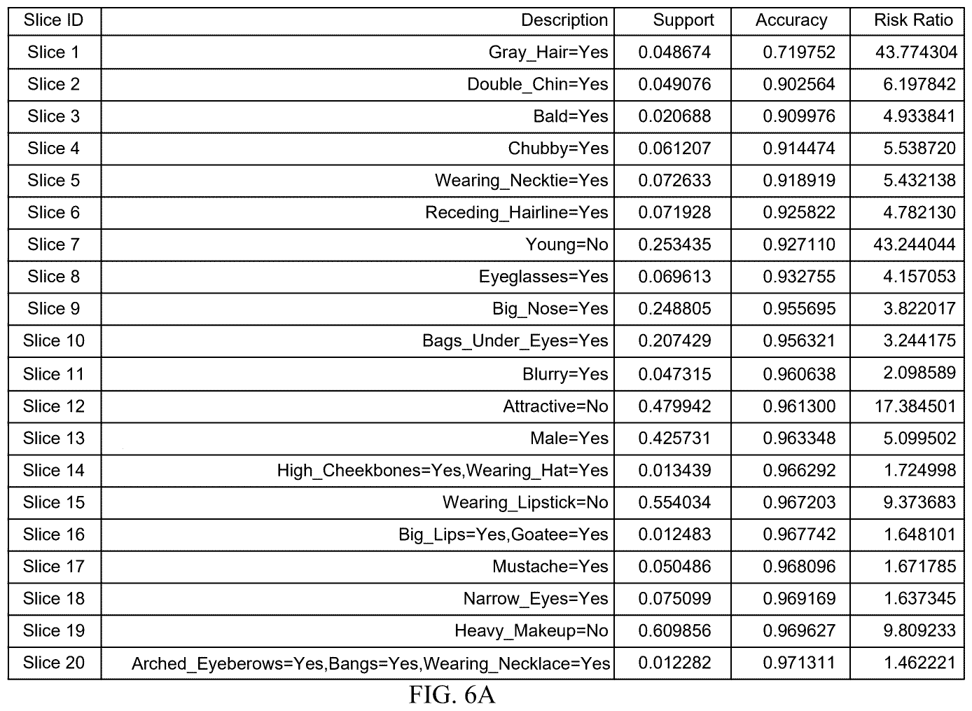

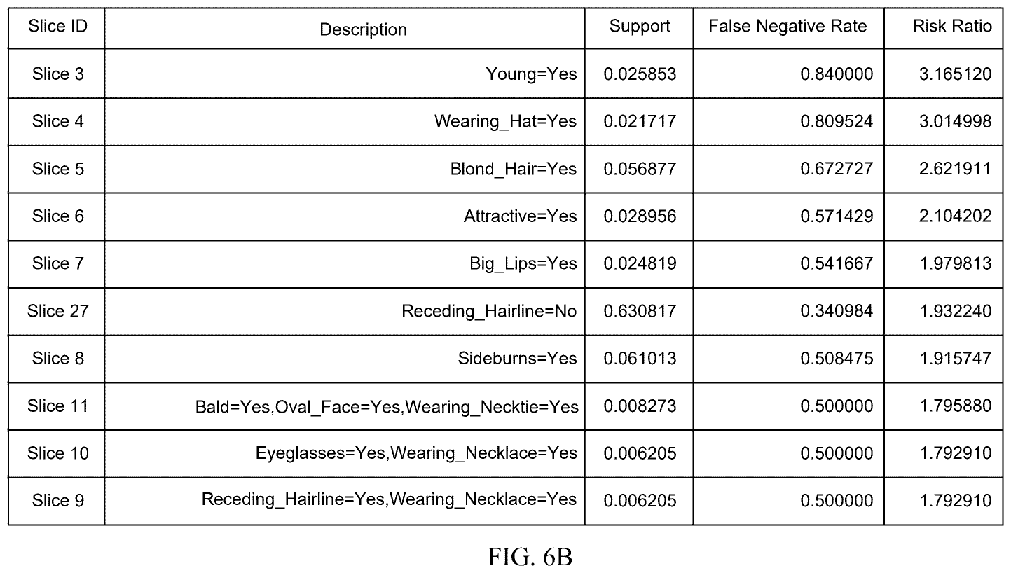

In some embodiments, data slice finding may incorporate metadata for machine learning model validation techniques. These techniques take interpretable metadata as input and produce data slices that highlight potential model issues, such as slices with lower accuracy than the model's average accuracy. To do so, heuristics may be used to segment the search space into data cubes with subpar evaluation metrics. For example, a machine learning model may be trained to determine hair color of humans based on profile-view photos (see also FIGS. 6A-7 and related description herein). Each photo may have an associated label, such as “gray” or “not gray,” and may be accompanied by a table of interpretable metadata with attributes such as “gender,” “age,” “smiling,” “wearing a hat,” “long hair,” etc. A user, such as an ML expert illustrated in FIG. 4 herein, might use data slice finding to identify metadata value combinations that reveal model problems. For example, an increased number of prediction errors and lower accuracy in a data slice may be detected using such data slice finding techniques. In addition, and using results of such data slicing techniques, the user may receive further quantitative information pertaining to validation of the given machine learning model, such as that, while the model has a high overall accuracy (e.g. 99%), a portion of the data, such as that which is defined in a given slice described by {age<20, long hair=False}, currently has a low accuracy (e.g. 40%).

Slice Finding techniques, such as those described in embodiments herein, are thus integral to the validation of machine learning models. Furthermore, and in contrast to previous methods for incorporating slice finding for validation of machine learning models, the techniques described herein are scalable, due, at least in part, to the use of Frequent Pattern Mining. In some embodiments, Frequent Pattern Mining may be applied in order to narrow down a search space of data slices when completing a search for relevant and/or generalized edge cases. Frequent Pattern Mining may be implemented using algorithms such as DivExplorer, according to some embodiments. When applied, Frequent Pattern Mining may be used to focus on slices with a high number of samples (frequent patterns), thus removing smaller slices from the search space and significantly decreasing the processing time required to identify slices.

Moreover, the methods and techniques described herein may be configured to provide identified data slices in a customizable manner, such that data slices with a high frequency of incorrect predictions (e.g., low accuracy) and that are associated with being either false positive or false negative types of error may be provided, for more directed detection of different types of edge cases and/or patterns within the model. By determining and identifying data slices specifically by error type, a user may better determine root causes of those specific types of errors, and better determine how to proceed with more directed retraining(s) of the specific machine learning model.

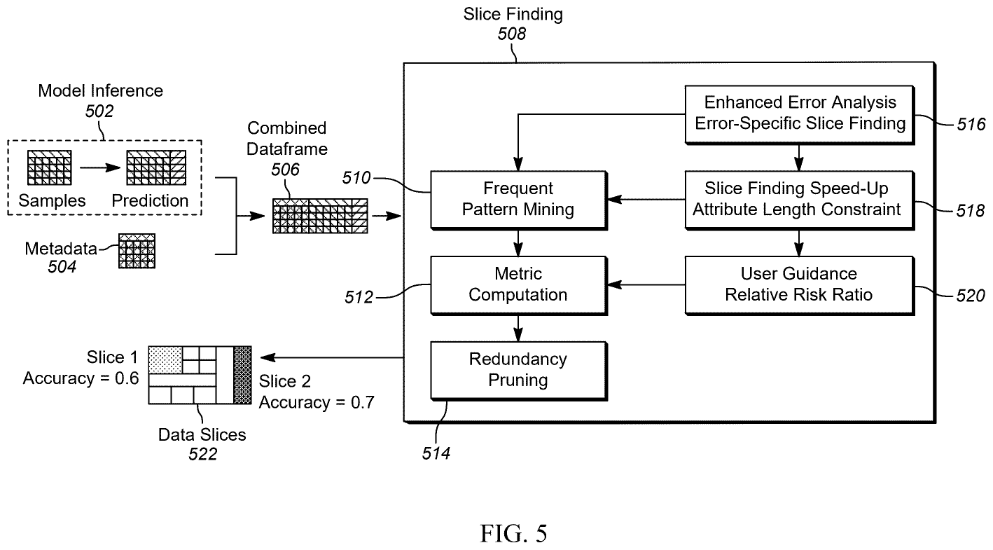

Furthermore, and in contrast to previous methods for incorporating slice finding for validation of machine learning models, the methods and techniques described herein provide quantifiable information pertaining to identified slices, in addition to the standard values such as “support.” Customized performance metrics, such as accuracy, precision, recall, etc., are provided to the user in order to fit the needs for determining validation of a domain-specific machine learning model. In addition, a “relative risk ratio” or any other guidance metric may be determined in order to help a user determine which particular combinations of attributes may lead to outliers and/or other problematic correlations, such as false positive or false negative errors, within the model. Such performance metrics, guidance metrics, additional analysis information, such as relative risk ratio, provide a more comprehensive analysis for the user during a process of validating a machine learning model. Moreover, when used in conjunction with redundancy pruning (see also FIG. 5 and related description herein), the methods and techniques described herein provide a more effective understanding of a current model's limitations.

In some embodiments, methods and techniques described herein for data slice finding significantly accelerates the data slice computation process and facilitates the analysis of model slices from multiple perspectives of error types. Such configurations combine a powerful frequent pattern mining tool with a pruning strategy, which is specifically designed to reduce the computational complexity of the process. Moreover, the data slice analysis may be determined by specific error type (e.g., false negative, false positive, etc.), enabling a more comprehensive analysis of a machine learning model. By further incorporating guidance metrics, such as relative risk ratio, identified slices may be ranked and thus provided to the user in ways that allow users to focus on the more critical data slices during their analysis. Thus, data slice finding techniques described herein are prepared for real-world industrial applications, where time, efficiency, and accuracy are paramount when conducting a rigorous process for validation of a machine learning model, in order to ensure consistent and precise performance of the model across various domain-specific scenarios.

The present disclosure continues with detailing the types of machine learning models that the methods and systems described herein may be used to validate, followed by description pertaining to using frequent pattern mining to provide improved methods for identifying slices within a validation dataset. The present disclosure then demonstrates the versatility of the methods and systems described herein for use in validation and edge case detection of classification, object detection, and regression models.

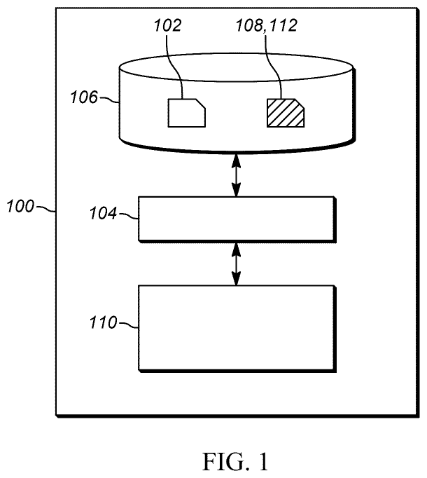

FIG. 1 illustrates a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the neural network using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

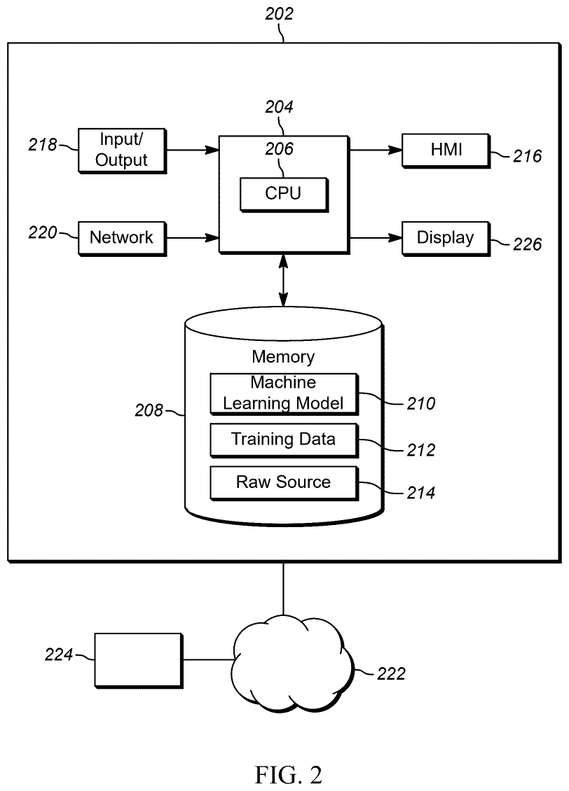

FIG. 2 illustrates a computer-implemented method for training and utilizing a neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 214.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 214. The raw source dataset 214 may include raw or unprocessed sensor data that may be representative of an input dataset for a machine-learning system. The raw source dataset 214 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 214. The raw source data 214 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 214 to identify the presence of the particular features. The machine-learning algorithm 210 may be configured to identify a feature in the raw source data 214 as a predetermined feature (e.g., pedestrian). The raw source data 214 may be derived from a variety of sources. For example, the raw source data 214 may be actual input data collected by a machine-learning system. The raw source data 214 may be machine generated for testing the system. As an example, the raw source data 214 may include raw video images from a camera.

In the example, the machine-learning algorithm 210 may process raw source data 214 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

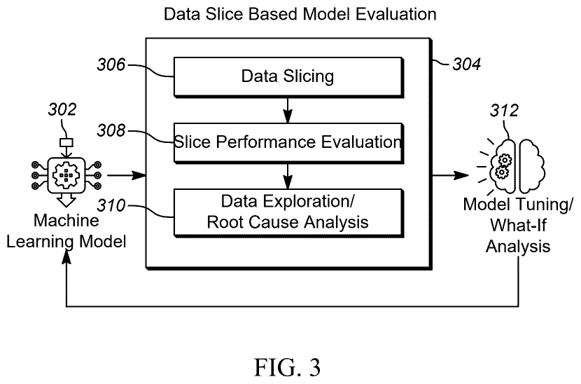

FIG. 3 illustrates an iterative flow diagram for a data slice based model evaluation 304, such as for validation and edge case detection of a machine learning model 302, according to some embodiments. The system may include a machine learning model 302, such as a classification model, an object detection model, a regression model, or any other computer vision model. Furthermore, FIG. 3 discloses a high-level workflow 304 for model analysis and iteration, which may otherwise be referred to herein as a validation process. Additional and detailed workflows for methods for performing validation of a machine learning model are illustrated in FIGS. 4 and 5, and further described below.

As shown in FIG. 3, data slice based model evaluation 304 may include identifying data slices within a validation dataset, as indicated in block 306. A directed data slice identification process may be based, at least in part, on some user inputs, such as an attribute length constraint and/or a specific type of error to be used when identifying slices. Such example embodiments are additionally discussed with regard to FIG. 5 below.

As indicated in block 308, performance metrics, guidance metrics, and additional domain-specific metrics may be determined by the system described herein in order to provide slice performance evaluation criteria to the user. In some embodiments, a user may then use such results of the validation process in order to determine root cause of certain types of limitations for the current state of the model, and further explore the data slices, as indicated in block 310. Based on such observations, the system and method may provide an indication to the user to iterate over the model, as illustrated with model tuning/what-if analysis 312 in the figure, by retraining while re-prioritizing certain data slices over others.

In various cases, users and/or ML experts may request to slice the data into various scenarios, thoroughly evaluate their models 302, understand the failure cases, and develop strategies 312 to tune the models to improve performance. As such a user-driven comparison and analysis step in block 310 of the identified data slices may itself be time consuming, the system and methods described herein are configured to provide the identified slices to the user and categorize them by error type, support, performance metric values, relative risk ratio values, etc., allowing for a more streamlined validation process that is driven by algorithmic results.

Data slicing and domain-specific needs may be different for the various environments and applications that the data and ML model is utilized for. In the context of autonomous driving, for example, ML experts may be interested in modeling the ultrasonic sensors to understand the car surroundings (see also FIG. 9 and related description herein). Such modeling may be a critical modality in the sensor-fusion pipeline to enhance the overall system robustness. The raw ultrasonic sensor data may not be directly interpretable by a human. However, every sample may also contain metadata describing the experiment setup, for example, the object type, distance, sensor location, time of day, etc. Thus, it may be beneficial to utilize a trained decision-tree-based model to classify nearby objects' heights (as “high” or “low”) using the sensor-derived tabular features. While evaluating their models, it may also be beneficial to tune and/or verify that certain critical objects have a low error rate. In some cases, it may require a trade-off between the respective performances of non-critical objects critical objects. For example, children, curbstones, and nearby cars may have the highest priority in terms of object detection. Therefore, during respective evaluation iterations, it may be important to slice the data, evaluate the model on the data subsets, and retrain the model with different parameters to mitigate the potential for critical mistakes. By providing data slices that are not only themselves relevant to edge case detection but by also providing them based on domain-specific performance metrics, the system and methods described herein provide a streamlined and efficient validation process to users.

In another example, such as in a use case for fire detection applications, it may be beneficial to train a deep neural network to detect smoke and fire based on video frames. In this scenario of training a model, the video segment may be associated with interpretable metadata that describes the video collection process in detail, such as description pertaining to the recording location, time of day, the smoke density, and whether there were blinking lights in the scene. Following initial training, the overall performance of this model may be high. However, edge case detection, using validation processes described herein, may still be essential in order to identify particular types of situations where the model failed.

FIG. 4 illustrates another iterative flow diagram for validation and edge case detection of a machine learning model. In some embodiments, FIG. 4 illustrates a process of performing validation of a machine learning model, and may be understood to be an iterative process, as indicated by the arrow in the figure labeled “New Model Iteration.” Moreover, it should be understood that the flowchart illustrated in FIG. 4 may be executed by one or more computing devices that are configured to perform the steps shown in FIG. 4. In addition to performing steps shown in the figure that collectively describe a validation process, the one or more computing devices may be further configured to provide/receive certain information to/from the ML expert or user. For example, a user may define an attribute length constraint, such as that which is illustrated in block 518 of FIG. 5. In another example, and following the identification of a new set of data slices, the computing devices may be configured to provide the data slices and corresponding metrics to the user, such as via a user interface.

In some embodiments, a validation dataset 402 may be an input to the overall system that is shown in FIG. 4. The validation data may include raw images or tabular features extracted from sensor signals (see also examples of sensor signals described with respect to FIGS. 9-14). Furthermore, metadata (e.g., interpretable features that may be utilized to slice the data), and ground truth labels (e.g., object classes or obstacle height) may also be used as inputs to the validation process (see also illustrations shown in FIG. 5). In the methods described herein, validation datasets, such as validation dataset 402, are used within a validation dataset rather than a training dataset. Furthermore, as ground truth labels exist for the corresponding data samples within the validation dataset, the validation process itself may be considered as a supervised learning technique. Moreover, depending upon the specific type of machine learning model that is being validated, the validation dataset may include image information, tabular information, radar information, sonar information, or sound information.

The system described herein then uses a slice finding algorithm 406 to identify data slices where the performance measures or metrics (e.g., accuracy) are the most different from the overall model performance. In one example, the slice finding algorithm 406 may be a DivExplorer algorithm, which may be a Frequent Pattern Mining-based approach for such a task. The metadata from the validation data set 402 may be utilized by the data slice finding algorithm 406. Furthermore, the machine learning model 404 may identify predictions based on the features from the validation dataset 402. The machine learning model may then provide the predictions to data slice finder 406. Data slicing is additionally illustrated in FIG. 5 and further described in the corresponding description herein.

Following a process of identifying data slices, the data slicing algorithm 406 may then output the data slices to a slice-based performance evaluation 408. The slice-based performance evaluation interface 408 may include an interface or tool that is output on a display (e.g., computer, tablet, phone, or remote display). The evaluation interface 408 may include a slice matrix view 410. Thus, the system may allow users to quickly visualize and summarize the identified data slices using the slice matrix view 410. The slice matrix view may display where rows correspond to slices, and columns, to slice descriptions and associated metrics. The user may be able to select slices to view its details using a slice detail view 412 or some other slice distribution view. The slice detail view 412 may output, on an interface, present metadata distributions and correlations to the user. Both the matrix view and the detail view may output and allow the user to identify critical slices in the data, such as slices where the model performance has issues (e.g., false positive errors, false negative errors, etc.). Thus, the user may be able to select and identify various data and statistics associated with a particular slice that corresponds to be a specific attribute (e.g., in a case of image recognition, bald men.)

Upon a user selecting a specific slice, the user may utilize a test mitigating tool that is configured to adjust various parameters of the system (e.g., including ML model 404) to show a resulting effect to the adjustment. For example, when a critical slice is found, the user can test mitigating measures using a “Slice Prioritization-What-If Analysis” tool 416. The analysis tool 416 may utilize an algorithm, such as a shallow model 418, to evaluate the effect of optimizing the model for particular data slices. The algorithm may fit a shallow model 418 on top of the original model to estimate the effect of prioritized optimization. The shallow model 418 may be utilized to approximate the residual (e.g., errors) of the slices. The shallow model 418 may also be trained.

Upon a user finding a group of slices to optimize, they may have the ability to export the selected slices back to their programming environment, make changes on data, hyperparameter, or model, and insert the new model back into the system (e.g., via a visual interface of the system) to compare models, as indicated in block 422.

The system may output information to a ML expert to help modify the system for improvements on a specific application, such as fire detection or autonomous driving. In one example, in order to mitigate the problems found in the data slices, the expert strategy may attempt to increase the training dataset size, using data collection and data augmentation. To improve particular data slices, the ML expert may collect more samples in the same conditions of the slices of interest. They may then thoroughly inspect the new samples in order to ensure data quality. Another mitigation strategy that may be applied is data augmentation. For example, an ML expert may test different augmentation strategies, such as including frames with added noise and blur to their training dataset.

FIG. 5 illustrates a flow diagram for identifying slices using data samples and attributes of a validation dataset, according to some embodiments. In embodiments described herein, an algorithm that performs an interpretable data slice computation for an evaluation of a given machine learning model is configured to derive interpretable data slices from input attributes/metadata 504. Such identification of data slices must be easily comprehendible by an ML expert in order to aid in the understanding of a model, and its current and domain-specific successes and failures. In order to identify interpretable data slices in machine learning models during a validation process such as that which is illustrated in FIG. 5, the following key components may be applied and executed by computing devices configured to perform the validation of a given machine learning model.

As introduced above, model inference 502 may include data samples of a validation dataset, which are provided to a machine learning model (e.g., machine learning model 404), and may also include predictions that have been generated by the machine learning model. Furthermore, metadata 504 may include any type of interpretable attribute(s) that are associated with the data samples of the validation dataset. Attributes may additionally be referred to herein as key-value pairs. It should also be understood that one or more attributes may be associated with a given data sample, and that an absence of something may also be considered to be an attribute. For example, attributes of an image taken of an outdoor picnic at a park may include {sunny, no pavement}, wherein “sunny” may define the type of weather displayed in the image, and “no pavement” may indicate the lack of a street or sidewalk being visible in the image. In some embodiments, data samples, model predictions, and attributes may all be described as combined dataframe 506, and may be provided as inputs to an algorithm conducting the data slice finding techniques described herein.

As illustrated in block 508, data slice identification process may include three main components, namely frequent pattern mining 510, metric computation 512, and redundancy pruning 514. In a frequent pattern mining step 510, the algorithm is configured to search through the combined dataframe 506 for attributes which are common across two or more data samples. Continuing with the example above, the algorithm may search for data samples that share the attribute {sunny}, then may search for data samples that share the attribute combination {sunny, no pavement}, etc. In order to provide scalable data slice finding procedures to users, the embodiments described herein incorporate the use of error-specific slice finding 516 and an attribute length constraint 518, as illustrated within slice finding block 508 in FIG. 5. Such components of data slice finding techniques described in the present disclosure reduce time required to complete such validation processes by orders of magnitude. An example of such improvements to processing capabilities are additionally illustrated in FIG. 7 herein.

Moreover, as such a search through all attributes for all data samples may be extremely time consuming, and in particular depending upon a number of data samples and on a number of attributes associated with those data samples, an attribute length constraint may be applied during the search. As shown in slice finding speed-up attribute length constraint block 518, a user who has requested the validation of the given machine learning model may fix a maximum length of a string of attributes that is to be used during the search. An attribute length constraint imposes a restriction on a size of the eventual data slice description that will be provided in data slices 522, wherein the data slice description is defined by a number of key-value pairs (attributes). In the following paragraphs, along with the examples illustrated in FIGS. 6A-7 herein, an example of a validation process for a hair color classification model is used in order to further describe the main components of said validation process. However, it should be understood that the use of such an example machine learning model is not meant to restrict the usage of the embodiments described herein, and that any other type of classification, object detection, regression, or other computer vision model may be incorporated into the description herein.

In an example hair color classification model, a given data slice may be defined by {gender=Female, wearing_necktie=True, gray_hair=False}, which has a data slice description length of three. However, without the use of an attribute length constraint, data slices within data slices 522 could have description lengths that are as large as the total number of metadata features in the combined dataframe 506. Moreover, and without the attribute length constraint, the data slices can become exceedingly complex, thus making it difficult for human ML experts to comprehend, compare, and analyze them. Such a complexity arises from the extensive number of key-value pairs that are used to describe each data slice. The more the pairs, the more intricate the data slice becomes. Furthermore, the data slice finding algorithm must then search through all possible combinations of metadata attributes in order to identify problematic slices. Given the potentially unlimited number of metadata features, the search process can become exceedingly exhaustive and time-consuming, which can further hinder the efficiency of the algorithm.

In contrast to previous approaches that did not incorporate a restriction on key-value pairs during such a search process, embodiments described herein utilize the attribute length constraint input 518 to frequent pattern mining 510. This constraint is applied to the Frequent Pattern Mining process, restricting the description of data slices to a maximum of K items. The value of K can be determined by the user, which then provides flexibility and customizability based on time constraints of the ML expert themselves, on computing power of the computing devices performing the validation process, and other domain-specific needs.

In some embodiments, and during the frequent pattern mining step 510, if a pattern S of length equal to K is identified, the search process is halted at that point, and no other patterns containing S will be searched. The algorithm then proceeds to continue the search with the remaining patterns. This technique effectively limits the complexity of the data slices and reduces the search space for the algorithm, enhancing its efficiency.

In order to further optimize data slice finding techniques for an ML expert, enhanced error analysis techniques, as illustrated in block 516, may additionally be used as inputs to frequent pattern mining 510. In some embodiments, an ML expert may want to target data slices that exhibit trends of false positive errors, or of false negative errors. Thus, the system may efficiently calculate data slices for various error types in the model, providing a seamless option to switch between different error analyses. By separately identifying data slices by error type, an ML expert may then be provided with more useful and directed analysis results, and thus make more informed decisions about how to retrain their model. In particular, and in order to be able to correctly interpret root causes of certain types of errors, error-specific slice finding 516 ensures that data slices can be compared within separate categories. For example, if a data slice described as {Gender=Male, Long_Hair=True} exhibits low accuracy, it becomes difficult to ascertain whether the model is registering a false positive error, false negative error, or both, if data slices are not identified on a per-error-type basis. This complication arises because previous systems that applied data slicing techniques would identify data slices with overall low metrics, like accuracy, and aggregates multiple error types into a single slice. Thus, enhanced error analysis techniques 516 provides the certainty that multiples types of errors are not present within a same data slice, but rather are categorized by error type.

In some embodiments, enhanced error analysis 516 instructs frequent pattern mining 510 to execute a separate data slice finding instance for each error type, thus ensuring that resulting data slices are characterized by a consistent error type. For example, a data slice finding instance may be executed in order to detect the edge cases containing only false positive errors, and a separate data slice finding instance may be executed in order to detect the edge cases containing only false negative errors. This greatly simplifies and streamlines the analysis process, as users may then treat samples that share the same error type, making it easier for them to identify and understand the underlying model problems. As illustrated in FIG. 5, enhanced error analysis 516 and slice finding speed-up 518 may be used in conjunction with one another, and provided as inputs to frequent pattern mining 510.

As additionally illustrated in FIG. 5, user guidance block 520 may also be used when performing metric computation(s) in block 512. Subsequent to identifying data slices using frequent pattern mining 510, the system may be configured to determine, for each of the identified data slices, a value of a given performance metric based, at least in part, on the generated predictions and on the ground truth labels. As introduced above, performance metrics may include accuracy, precision, recall, or any other domain-specific metric of interest to the ML expert. User guidance 520 may be incorporated into the validation process in order to provide guided suggestions to the ML experts about which slice(s) should be evaluated first and/or are the most significant. It should be understood that, depending upon the type of model being validated and the given application of the model, such performance metrics may differ, but will all provide some type of “interestingness” ranking of the identified data slices. Such guidance allows ML experts to sort the data slices based on their interestingness, and allows them to concentrate their efforts on the more critical model problems. Rather than inspecting each individual data slice in order to gather such global information, relative risk ratio 520 may be used to determine the importance level of the various data slices.

In some embodiments, a relative risk ratio metric, which may be calculated as part of metric computation step 512, may be used in order to help an ML expert identify which data slices are the most affected by a particular condition. The metric may be used to depict the relative frequency of key attributes in data slices (such as gender, age, etc.) among outliers and inliers. Outliers may be defined herein as data samples with particular problems, such as false positive errors or false negative errors, while inliers may be defined herein as data samples that represent correctly classified samples (when continuing the example introduced above of validating a hair color classification model).

A relative risk ratio may be defined as the following: let a₀ be the number of times an attribute combination appears in the outliers, aᵢ be the number of times an attribute combination appears in the inliers, b₀ be the other outliers, and bᵢ be the other inliers. The relative risk ratio is therefore given by:

$$Relative Risk Ratio = \frac{{a}_{0} / ( {a}_{0} + {a}_{i} )}{{b}_{0} / ( {b}_{0} + {b}_{i} )} .$$

The relative risk ratio metric functions as a guide to the ML expert, allowing them to target and explore more intriguing slices. A relative risk ratio of R may be defined by data slices with a specific data slice description that are R times more likely to be outliers as opposed to inliers. More specifically, and for a given data slice of data slices 522, a relative risk ratio of 1, or R=1, may be understood as a data slice has no bearing on the likelihood of records being an outlier. A relative risk ratio of greater than 1, or R>1, indicates that the slice description of the given data slice increases the probability or risk of a sample being an outlier. Conversely, a risk ratio smaller than 1, or R<1, implies that a slice description decreases the probability of a sample being an outlier.

Following the completion of metric computation(s) 512, a redundancy pruning process may be performed onto the identified data slices, prior to providing the final set of data slices to the ML expert. In some embodiments, a redundancy pruning may be used to determine which data slices, if any, are to be removed. For example, a first data slice may be removed when it is determined that a set of common attributes that are shared with a second data slice has a quantifiable impact on a given performance metric that is less than a redundancy threshold with respect to the first data slice. In some embodiments, the redundancy threshold may be fixed by the ML expert, or may otherwise be provided to the computing devices that are performing the validation process, prior to the execution of step 514.

Once the redundancy pruning process is complete, data slices 522 may be provided to the ML expert. As multiple sets of data slices have been identified based on error types, multiple sets of data slices 522 may be provided. FIGS. 6A-6C illustrate examples of the types of sets of data slices that may be provided to an ML expert, and said figures continue with the example of a validation process for a hair color classification model. In the description that follows, FIG. 6A illustrates information pertaining to a set of data slices prior to utilizing an enhanced error analysis and during application of an attribute length constraint. FIG. 6B then illustrates information pertaining to another set of data slices during application of an enhanced error analysis for false negative type errors, application of the attribute length constraint, and further application of a calculation of a relative risk ratio. Finally, FIG. 6C illustrates information pertaining to yet another set of data slices during application of an enhanced error analysis for false positive type errors, application of the attribute length constraint, and further application of a calculation of a relative risk ratio.

FIG. 6A illustrates a listing of some of the identified slices for a given hair color classification model and the corresponding performance metric values for those slices, according to some embodiments. For the specific example model validation process being illustrated, the following training criteria was applied: a ResNet 50 model was used to classify hair color as “Gray” or “Not Gray” using the CelebFaces Attributes Dataset (CelebA), which is dataset that is a widely used benchmark, at the time of writing, in the computer vision community for image classification tasks. The CelebA dataset contains 202,599 face images of 10,177 celebrities, along with 40 binary (Yes/No) attribute annotations for each image: ‘5_o_Clock_Shadow’, ‘Arched_Eyebrows’, ‘Attractive’, ‘Bags_Under_Eyes’, ‘Bald’, ‘Bangs’, ‘Big_Lips’, ‘Big_Nose’, ‘Black_Hair’, ‘Blond_Hair’, ‘Blurry’, ‘Brown_Hair’, ‘Bushy_Eyebrows’, ‘Chubby’, ‘Double_Chin’, ‘Eyeglasses’, ‘Goatee’, ‘Gray_Hair’, ‘Heavy_Makeup’, ‘High_Checkbones’, ‘Male’, ‘Mouth_Slightly_Open’, ‘Mustache’, ‘Narrow_Eyes’, ‘No_Beard’, ‘Oval_Face’, ‘Pale_Skin’, ‘Pointy_Nose’, ‘Receding_Hairline’, ‘Rosy_Checks’, ‘Sideburns’, ‘Smiling’, ‘Straight_Hair’, ‘Wavy_Hair’, ‘Wearing_Earrings’, ‘Wearing_Hat’, ‘Wearing_Lipstick’, ‘Wearing_Necklace’, ‘Wearing_Necktie’, ‘Young’.

For this particular hair color classification model use case, each image within the CelebA dataset is assigned a label of ‘gray hair’ or ‘not gray hair’. A ResNet50 binary image classifier is then trained, leveraging a transfer learning approach. The data is divided into training, validation, and testing segments following an 8:1:1 ratio. After a series of iterative fine-tuning of hyperparameters, the model achieves a classification accuracy rate of 98.03%. Despite the high accuracy, the corresponding ML expert requests to delve deeper into the model's performance, particularly focusing on whether there are data slices where the model underperforms. In the given scenario, a minimal support of a data slice is set to 0.01, and the attribute length constraint is fixed at three. By considering all available metadata, the validation techniques described herein are able to consider all available metadata, and is able to explore a wider range of possible corner cases with respect to previous data slicing techniques, thus presenting a more comprehensive analysis of the model being examined. In FIG. 6A, the top 20 data slices, computed using methods and techniques described herein, are shown. While the overall model performance is very high, 98.03%, it may be understood, as illustrated in the figure, that some data subsets can have much lower accuracy. For example, in Slice 1 in FIG. 6A, wherein data samples contain a corresponding attribute of gray hair, the accuracy significantly drops to 71.98%. Thus, there are a significant number of false negative errors within in the validation data. This may additionally be understood by using the specific false negative error type analysis, as shown in FIG. 6B.

FIG. 6B illustrates another listing of some of the identified slices for the given hair color classification model introduced in FIG. 6A, wherein the identified slices have been organized by a relative risk ratio defined by false negative errors. For a more detailed understanding of model failure, FIG. 6B demonstrates the use of an enhanced error analysis that focuses on false negative type errors. Within the context of this specific implementation, a false negative type error may be defined as instances where the hair is gray, but is incorrectly predicted as not gray. The top ten worst-performing data slices, shown in FIG. 6B, provides a more granular perspective to the ML expert about the model's predictive performance, and are ranked by their relative risk ratio. Within the context of FIG. 6B, a performance metric defined as the false negative rate metric may be written as the following:

$$False Negative Rate = \frac{False Negatives}{False Negatives + True Positives} ,$$

wherein ‘False Negatives’ is the number of false negatives and ‘True Positives’ is the number of Truc Positives in the given data slice. As illustrated in FIG. 6B, the greatest risk of False Negatives occurs when the variable ‘Young’ equals ‘Yes’, suggesting to the ML expert that the model struggles to accurately classify gray hair in a young individual. The ML expert may then determine the root cause as there being a lack of training samples featuring young people with gray hair, and decide to retrain the model around those particular problematic slices.

FIG. 6C illustrates yet another listing of some of the identified slices for the given hair color classification model introduced in FIG. 6A, wherein the identified slices have been organized by a relative risk ratio defined by false positive errors. Within the context of this specific implementation, a false positive type error may be defined as instances where the hair is not gray, yet is incorrectly predicted as gray. The top ten worst-performing data slices, shown in FIG. 6C, provides a more granular perspective to the ML expert about the model's predictive performance, and are ranked by their relative risk ratio. Within the context of FIG. 6C, a performance metric defined as the false positive rate metric may be written as the following:

$$False Positive Rate = \frac{False Positives}{False Positives + True Negatives} ,$$

wherein ‘False Positives’ is the number of false positives and ‘True Negatives’ is the number of true negatives in the given data slice. As illustrated in FIG. 6C, the model is more prone to false positives when the hair color is not black. The ML expert, when presented with such information, may then decide to retrain the model around those particular problematic slices.

FIG. 7 illustrates a graphic for the given hair color classification model introduced in FIG. 6A that demonstrates an approximate amount of time that is saved when applying an attribute length constraint during validation of a machine learning model, according to some embodiments. As introduced above, providing scalable validation procedures may encompass parsing hundreds or more metadata features within a given validation dataset. FIG. 7 illustrates ‘With QuickSlicer,’ which again pertains to the validation of the hair color classification model and the application of an attribute length constraint, in contrast to ‘Without QuickSlicer,’ which pertains to the same validation process but without the application of an attribute length constraint. In the particular example illustrated in the figure, 40 metadata features are considered. While ‘Without QuickSlicer’ grows exponentially with the number of metadata features used, ‘With QuickSlicer’ grows linearly, making the process significantly faster and tractable. As additionally illustrated in the figure, if all 40 metadata features were to be considered, an estimated runtime for ‘Without QuickSlicer’ would take 20 days in order to compute all the data slices for the hair color classification model. In contrast, ‘With QuickSlicer’ requires only seconds to perform the same computation, demonstrating the orders of magnitude of time that the present disclosure saves when executing validation processes for machine learning models.

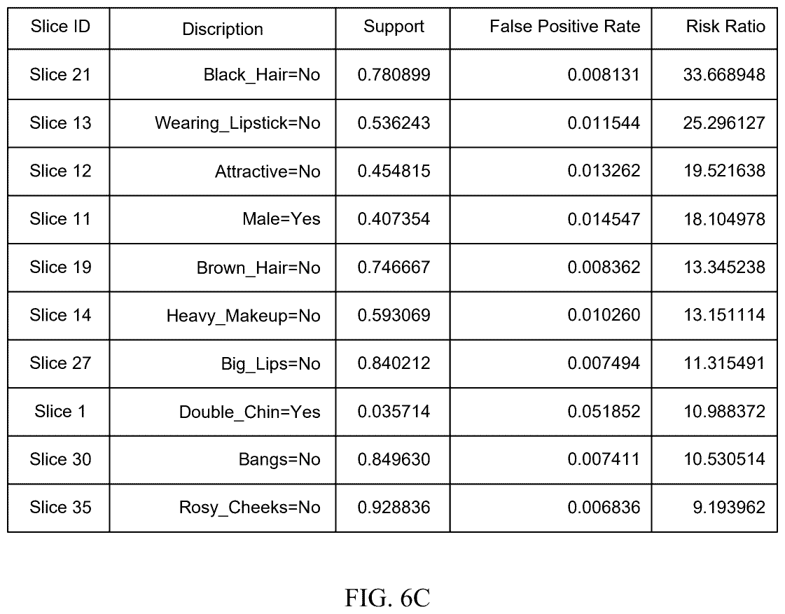

The methods and systems disclosed herein can be used in many different applications. Determining out-of-distribution data, edge cases, false positive errors, false negative errors, or other performance metric and domain-specific metrics can be useful for a plethora of technologies, examples of which are illustrated in FIGS. 8-14. FIG. 8 depicts a schematic diagram of an interaction between a computer-controlled machine 800 and a control system 802. Computer-controlled machine 800 includes actuator 804 and sensor 806. Actuator 804 may include one or more actuators and sensor 806 may include one or more sensors. Sensor 806 is configured to sense a condition of computer-controlled machine 800. Sensor 806 may be configured to sense ID and/or OOD data, and the corresponding processors can be configured to determine whether the data is ID or OOD according to the teachings herein. Sensor 806 may be configured to encode the sensed condition into sensor signals 808 and to transmit sensor signals 808 to control system 802. Non-limiting examples of sensor 806 include a camera, video sensor, radar, LiDAR, ultrasonic and motion sensors, temperature sensors, and the like. In one embodiment, sensor 806 is an optical sensor configured to sense optical images of an environment proximate to computer-controlled machine 800.

Control system 802 is configured to receive sensor signals 808 from computer-controlled machine 800. As set forth below, control system 802 may be further configured to compute actuator control commands 810 depending on the sensor signals and to transmit actuator control commands 810 to actuator 804 of computer-controlled machine 800.

As shown in FIG. 8, control system 802 includes receiving unit 812. Receiving unit 812 may be configured to receive sensor signals 808 from sensor 806 and to transform sensor signals 808 into input signals x. In an alternative embodiment, sensor signals 808 are received directly as input signals x without receiving unit 812. Each input signal x may be a portion of each sensor signal 808. Receiving unit 812 may be configured to process each sensor signal 808 to product each input signal x. Input signal x may include data corresponding to an image recorded by sensor 806.

Control system 802 includes a classifier 814. Classifier 814 may be configured to classify input signals x into one or more labels using a machine-learning algorithm, such as a neural network described above. Classifier 814 is configured to be parametrized by parameters, such as those described above (e.g., parameter θ). Parameters θ may be stored in and provided by non-volatile storage 816. Classifier 814 is configured to determine output signals y from input signals x. Each output signal y includes information that assigns one or more labels to each input signal x. Classifier 814 may transmit output signals y to conversion unit 818. Conversion unit 818 is configured to covert output signals y into actuator control commands 810. Control system 802 is configured to transmit actuator control commands 810 to actuator 804, which is configured to actuate computer-controlled machine 800 in response to actuator control commands 810. In another embodiment, actuator 804 is configured to actuate computer-controlled machine 800 based directly on output signals y.

Upon receipt of actuator control commands 810 by actuator 804, actuator 804 is configured to execute an action corresponding to the related actuator control command 810. Actuator 804 may include a control logic configured to transform actuator control commands 810 into a second actuator control command, which is utilized to control actuator 804. In one or more embodiments, actuator control commands 810 may be utilized to control a display instead of or in addition to an actuator.

In another embodiment, control system 802 includes sensor 806 instead of or in addition to computer-controlled machine 800 including sensor 806. Control system 802 may also include actuator 804 instead of or in addition to computer-controlled machine 800 including actuator 804.

As shown in FIG. 8, control system 802 also includes processor 820 and memory 822. Processor 820 may include one or more processors. Memory 822 may include one or more memory devices. The classifier 814 of one or more embodiments may be implemented by control system 802, which includes non-volatile storage 816, processor 820 and memory 822.

Non-volatile storage 816 may include one or more persistent data storage devices such as a hard drive, optical drive, tape drive, non-volatile solid-state device, cloud storage or any other device capable of persistently storing information. Processor 820 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 822. Memory 822 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 820 and memory 822 may be configured to provide collected data to one or more other computing devices that are configured to train and/or validate the machine learning model within domain-specific embodiments shown throughout FIGS. 8-14. Such collected data may be used to generate training datasets and validation datasets for various stages in preparing and executing a machine learning model into industry-grade applications. Within a context described herein with regard to edge case detection, processor 820 and memory 822 may be coupled to or otherwise remotely connected to computing devices that may then conduct validation processes such as those described above.

Processor 820 may be configured to read into memory 822 and execute computer-executable instructions residing in non-volatile storage 816 and embodying one or more machine-learning algorithms and/or methodologies of one or more embodiments. Non-volatile storage 816 may include one or more operating systems and applications. Non-volatile storage 816 may store compiled and/or interpreted from computer programs created using a variety of programming languages and/or technologies, including, without limitation, and cither alone or in combination, Java, C, C++, C #, Objective C, Fortran, Pascal, Java Script, Python, Perl, and PL/SQL.

Upon execution by processor 820, the computer-executable instructions of non-volatile storage 816 may cause control system 802 to implement one or more of the machine-learning algorithms and/or methodologies as disclosed herein. Non-volatile storage 816 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 9 depicts a schematic diagram of control system 802 configured to control vehicle 900, which may be an at least partially autonomous vehicle or an at least partially autonomous robot. Vehicle 900 includes actuator 804 and sensor 806. Sensor 806 may include one or more video sensors, cameras, radar sensors, ultrasonic sensors, LiDAR sensors, and/or position sensors (e.g. GPS). One or more of the one or more specific sensors may be integrated into vehicle 900. In the context of sign-recognition and processing as described herein, the sensor 806 is a camera mounted to or integrated into the vehicle 900. Alternatively or in addition to one or more specific sensors identified above, sensor 806 may include a software module configured to, upon execution, determine a state of actuator 804. One non-limiting example of a software module includes a weather information software module configured to determine a present or future state of the weather proximate vehicle 900 or other location.

Classifier 814 of control system 802 of vehicle 900 may be configured to detect objects in the vicinity of vehicle 900 dependent on input signals x. In such an embodiment, output signal y may include information characterizing the vicinity of objects to vehicle 900. Actuator control command 810 may be determined in accordance with this information. The actuator control command 810 may be used to avoid collisions with the detected objects.

In embodiments where vehicle 900 is an at least partially autonomous vehicle, actuator 804 may be embodied in a brake, a propulsion system, an engine, a drivetrain, or a steering of vehicle 900. Actuator control commands 810 may be determined such that actuator 804 is controlled such that vehicle 900 avoids collisions with detected objects. Detected objects may also be classified according to what classifier 814 deems them most likely to be, such as pedestrians or trees. The actuator control commands 810 may be determined depending on the classification. In a scenario where an adversarial attack may occur, the system described above may be further trained to better detect objects or identify a change in lighting conditions or an angle for a sensor or camera on vehicle 900.

In other embodiments where vehicle 900 is an at least partially autonomous robot, vehicle 900 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 810 may be determined such that a propulsion unit, steering unit and/or brake unit of the mobile robot may be controlled such that the mobile robot may avoid collisions with identified objects.

In another embodiment, vehicle 900 is an at least partially autonomous robot in the form of a gardening robot. In such embodiment, vehicle 900 may use an optical sensor as sensor 806 to determine a state of plants in an environment proximate vehicle 900. Actuator 804 may be a nozzle configured to spray chemicals. Depending on an identified species and/or an identified state of the plants, actuator control command 810 may be determined to cause actuator 804 to spray the plants with a suitable quantity of suitable chemicals.

Vehicle 900 may be an at least partially autonomous robot in the form of a domestic appliance. Non-limiting examples of domestic appliances include a washing machine, a stove, an oven, a microwave, or a dishwasher. In such a vehicle 900, sensor 806 may be an optical sensor configured to detect a state of an object which is to undergo processing by the household appliance. For example, in the case of the domestic appliance being a washing machine, sensor 806 may detect a state of the laundry inside the washing machine. Actuator control command 810 may be determined based on the detected state of the laundry.

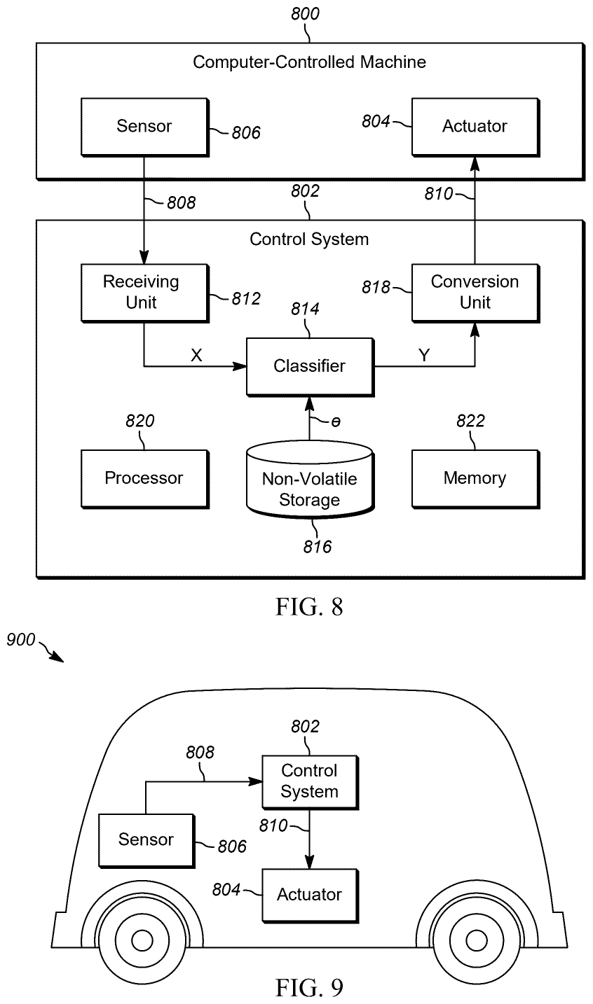

FIG. 10 depicts a schematic diagram of control system 802 configured to control system 1000 (e.g., manufacturing machine), such as a punch cutter, a cutter or a gun drill, of manufacturing system 1002, such as part of a production line. Control system 802 may be configured to control actuator 804, which is configured to control system 1000 (e.g., manufacturing machine).

Sensor 806 of system 1000 (e.g., manufacturing machine) may be an optical sensor configured to capture one or more properties of manufactured product 1004. Classifier 814 may be configured to determine a state of manufactured product 1004 from one or more of the captured properties. Actuator 804 may be configured to control system 1000 (e.g., manufacturing machine) depending on the determined state of manufactured product 1004 for a subsequent manufacturing step of manufactured product 1004. The actuator 804 may be configured to control functions of system 1000 (e.g., manufacturing machine) on subsequent manufactured product 1006 of system 1000 (e.g., manufacturing machine) depending on the determined state of manufactured product 1004.

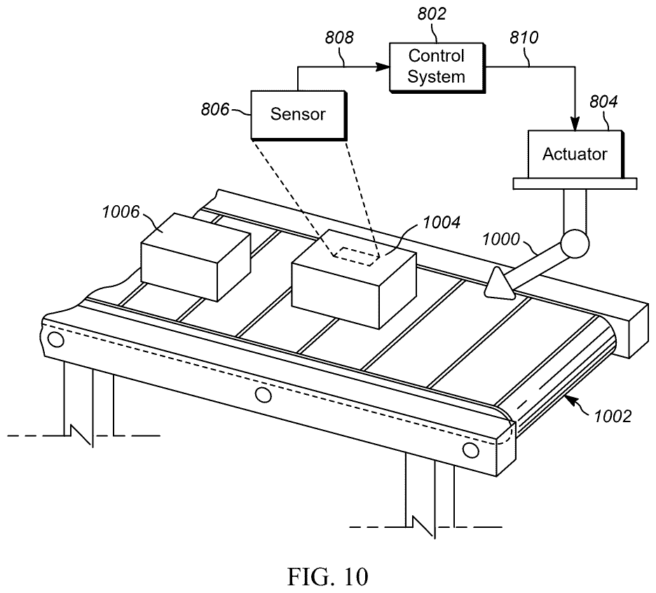

FIG. 11 depicts a schematic diagram of control system 802 configured to control power tool 1100, such as a power drill or driver, that has an at least partially autonomous mode. Control system 802 may be configured to control actuator 804, which is configured to control power tool 1100.

Sensor 806 of power tool 1100 may be an optical sensor configured to capture one or more properties of work surface 1102 and/or fastener 1104 being driven into work surface 1102. Classifier 814 within control system 802 may be configured to determine a state of work surface 1102 and/or fastener 1104 relative to work surface 1102 from one or more of the captured properties. The state may be fastener 1104 being flush with work surface 1102. The state may alternatively be hardness of work surface 1102. Actuator 1104 may be configured to control power tool 1100 such that the driving function of power tool 1100 is adjusted depending on the determined state of fastener 1104 relative to work surface 1102 or one or more captured properties of work surface 1102. For example, actuator 1104 may discontinue the driving function if the state of fastener 1104 is flush relative to work surface 1102. As another non-limiting example, actuator 1104 may apply additional or less torque depending on the hardness of work surface 1102.

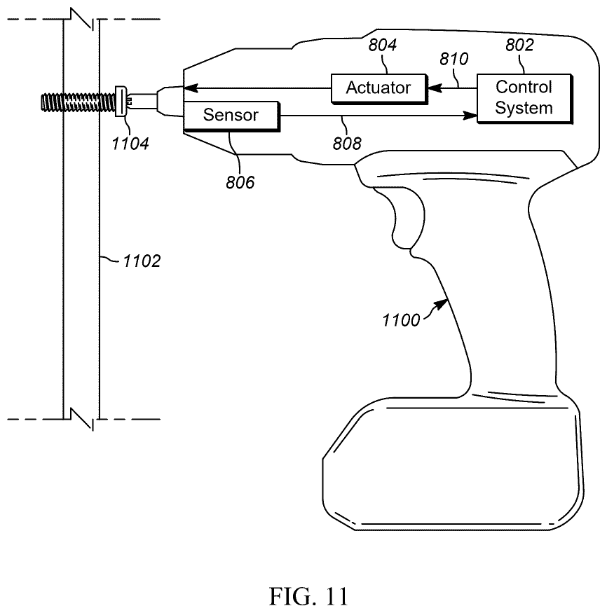

FIG. 12 depicts a schematic diagram of control system 802 configured to control automated personal assistant 1200. Control system 802 may be configured to control actuator 804, which is configured to control automated personal assistant 1200. Automated personal assistant 1200 may be configured to control a domestic appliance, such as a washing machine, a stove, an oven, a microwave or a dishwasher.

Sensor 806 may be an optical sensor and/or an audio sensor. The optical sensor may be configured to receive video images of gestures 1204 of user 1202. The audio sensor may be configured to receive a voice command of user 1202.

Control system 802 of automated personal assistant 1200 may be configured to determine actuator control commands 810 configured to control system 802. Control system 802 may be configured to determine actuator control commands 810 in accordance with sensor signals 808 of sensor 806. Automated personal assistant 1200 is configured to transmit sensor signals 808 to control system 802. Classifier 814 of control system 802 may be configured to execute a gesture recognition algorithm to identify gesture 1204 made by user 1202, to determine actuator control commands 810, and to transmit the actuator control commands 810 to actuator 804. Classifier 814 may be configured to retrieve information from non-volatile storage in response to gesture 1204 and to output the retrieved information in a form suitable for reception by user 1202.

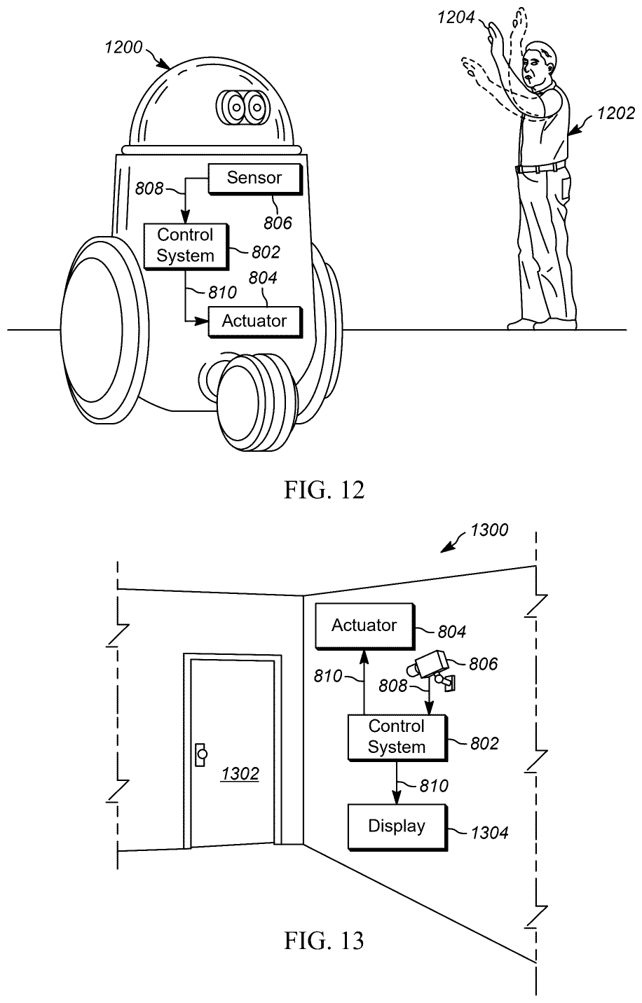

FIG. 13 depicts a schematic diagram of control system 802 configured to control monitoring system 1300. Monitoring system 1300 may be configured to physically control access through door 1302. Sensor 806 may be configured to detect a scene that is relevant in deciding whether access is granted. Sensor 806 may be an optical sensor configured to generate and transmit image and/or video data. Such data may be used by control system 802 to detect a person's face.

Classifier 814 of control system 802 of monitoring system 1300 may be configured to interpret the image and/or video data by matching identities of known people stored in non-volatile storage 816, thereby determining an identity of a person. Classifier 814 may be configured to generate and an actuator control command 810 in response to the interpretation of the image and/or video data. Control system 802 is configured to transmit the actuator control command 810 to actuator 804. In this embodiment, actuator 804 may be configured to lock or unlock door 1302 in response to the actuator control command 810. In other embodiments, a non-physical, logical access control is also possible.

Monitoring system 1300 may also be a surveillance system. In such an embodiment, sensor 806 may be an optical sensor configured to detect a scene that is under surveillance and control system 802 is configured to control display 1304. Classifier 814 is configured to determine a classification of a scene, e.g. whether the scene detected by sensor 806 is suspicious. Control system 802 is configured to transmit an actuator control command 810 to display 1304 in response to the classification. Display 1304 may be configured to adjust the displayed content in response to the actuator control command 810. For instance, display 1304 may highlight an object that is deemed suspicious by classifier 814. Utilizing an embodiment of the system disclosed, the surveillance system may predict objects at certain times in the future showing up.

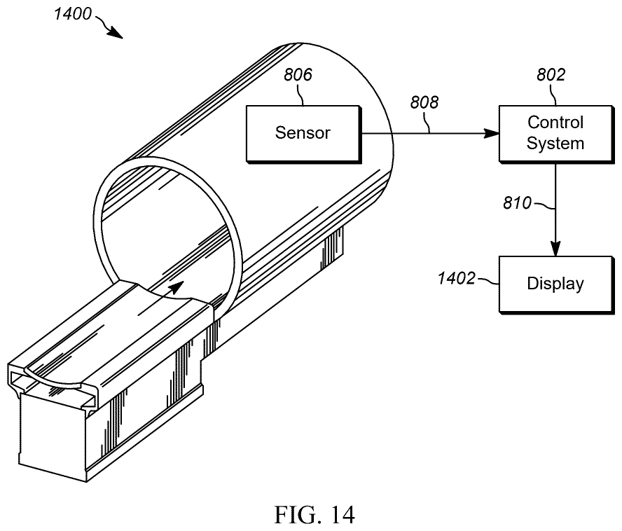

FIG. 14 depicts a schematic diagram of control system 802 configured to control imaging system 1400, for example an MRI apparatus, x-ray imaging apparatus or ultrasonic apparatus. Sensor 806 may, for example, be an imaging sensor. Classifier 814 may be configured to determine a classification of all or part of the sensed image. Classifier 814 may be configured to determine or select an actuator control command 810 in response to the classification obtained by the trained neural network. For example, classifier 814 may interpret a region of a sensed image to be potentially anomalous. In this case, actuator control command 810 may be determined or selected to cause display 1402 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a machine learning network, comprising:
providing a validation dataset to a machine learning model, wherein the validation dataset comprises:
data samples;
attributes that correspond to respective ones of the data samples; and
ground truth labels;
executing the machine learning model to generate predictions associated with the data samples of the validation dataset; and
executing a slice finding model, wherein the executing comprises:
identifying slices associated with the validation dataset, wherein the identifying the slices comprises:
receiving an indication of a length constraint associated with the attributes; and
for each of the slice identifications,
determining a frequency of a number of the attributes that are common across two or more of the data samples, wherein the number of the attributes does not exceed the length constraint associated with the attributes; and
defining a given slice based, at least in part, on the attributes that are common across the two or more of the data samples and on the frequency of the number of common attributes;
determining, for each of the identified slices, a performance metric value based, at least in part, on the generated predictions and on the ground truth labels; and
displaying, via a user interface, the identified slices and corresponding performance metric values to a user of the machine learning network.

2. The computer-implemented method of claim 1, wherein the identifying the slices further comprises:
receiving another indication of a type of error that is to be used to identify the slices; and
for each of the slice identifications,
defining, for each of the slice identifications, the given slice based, at least in part, on:
the attributes that are common across the two or more of the data samples;
the frequency of the number of the common attributes; and
the common attributes being associated with the type of error.

3. The computer-implemented method of claim 2, wherein the type of error is a false positive error or a false negative error.

4. The computer-implemented method of claim 2, wherein the executing the slice finding model further comprises:
determining, for each of the identified slices, a relative risk ratio based, at least in part, on the generated predictions, on the ground truth labels, and on the type of error; and
additionally displaying, via the user interface, the identified slices for the user based, at least in part, on a hierarchy of the corresponding relative risk ratios.

5. The computer-implemented method of claim 1, wherein the executing the slice finding model further comprises:
performing redundancy pruning onto the identified slices, wherein:
a first one of the slices is removed based, at least in part, on determining that common attributes of a second one of the slices has a quantifiable impact on the performance metric value that is less than a redundancy threshold with respect to the first one of the slices; and
the first slice comprises at least the common attributes of the second slice; and
displaying, via the user interface, remaining identified slices and the corresponding performance metric values to the user of the machine learning network.

6. The computer-implemented method of claim 1, further comprising:
generating a subsequent training dataset based, at least in part, on respective ones of the data samples within one or more of the identified slices that have inferior performance metric values with respect to other ones of the identified slices;
providing the subsequent training dataset to the machine learning model; and
executing the machine learning model to generate updated predictions associated with the subsequent training dataset.

7. The computer-implemented method of claim 1, wherein the data samples are indicative of image information, tabular information, radar information, sonar information, or sound information.

8. A system, comprising:
one or more processors; and
memory having program instructions that, when executed by the one or more processors, cause the one or more processors to:
provide a validation dataset to a machine learning model, wherein the validation dataset comprises:
data samples;
attributes that correspond to respective ones of the data samples; and
ground truth labels;
execute the machine learning model to generate predictions associated with the data samples of the validation dataset; and
execute a slice finding model, wherein the execution of the slice finding model further cause the one or more processors to:
identify slices associated with the validation dataset, wherein the identification of the slices comprises:
receive an indication of a length constraint associated with the attributes;
for each of the slice identifications,
determine a frequency of a number of the attributes that are common across two or more of the data samples, wherein the number of the attributes does not exceed the length constraint associated with the attributes; and
define a given slice based, at least in part, on the attributes that are common across the two or more of the data samples and on the frequency of the number of common attributes;
determine, for each of the identified slices, a performance metric value based, at least in part, on the generated predictions and on the ground truth labels; and
display, via a user interface, the identified slices and corresponding performance metric values to a user.

9. The system of claim 8, wherein to identify the slices, the program instructions further cause the one or more processors to:
receive another indication of a type of error that is to be used to identify the slices, wherein the type of error is a false positive error or a false negative error; and
for each of the slice identifications,
define the given slice based, at least in part, on:
the attributes that are common across the two or more of the data samples;
the frequency of the number of the common attributes; and
the common attributes being associated with the false positive error or the false negative error.

10. The system of claim 9, wherein to execute the slice finding model, the program instructions further cause the one or more processors to:
determine, for each of the identified slices, a relative risk ratio based, at least in part, on the generated predictions, on the ground truth labels, and on the type of error; and
additionally display, via the user interface, the identified slices for the user based, at least in part, on a hierarchy of the corresponding relative risk ratios.

11. The system of claim 8, wherein to execute the slice finding model, the program instructions further cause the one or more processors to:
perform redundancy pruning onto the identified slices, wherein:
a first one of the slices is removed based, at least in part, on determining that common attributes of a second one of the slices has a quantifiable impact on the performance metric value that is less than a redundancy threshold with respect to the first one of the slices; and
the first slice comprises at least the common attributes of the second slice; and
display, via the user interface, remaining identified slices and the corresponding performance metric values to the user.

12. The system of claim 8, wherein the length constraint associated with the attributes is smaller than a total number of the attributes within the validation dataset.

13. The system of claim 8, wherein the data samples are indicative of image information, tabular information, radar information, sonar information, or sound information.

14. The system of claim 8, wherein the machine learning model is a classification model, an object detection model, or a regression model.

15. The system of claim 8, wherein the performance metric is accuracy, precision, or recall.

16. The system of claim 8, wherein to execute the slice finding model, the program instructions further cause the one or more processors to organize, via the user interface, the identified slices for the user based, at least in part, on a hierarchy of the corresponding performance metric values.

17. One or more non-transitory, computer-readable media storing program instructions that, when executed on or across one or more processors, cause the one or more processors to:
receive a combined dataframe, wherein the combined dataframe comprises:
data samples of a validation dataset;
attributes that correspond to respective ones of the data samples;
ground truth labels;
predictions, generated by a machine learning model;
receive an indication of an length constraint associated with the attributes to be used when identifying slices; and
execute a slice finding model, wherein the execution of the slice finding model further cause the one or more processors to:
identify slices associated with the validation dataset, wherein, for each of the slice identifications, the program instructions cause the one or more processors to:
determine a frequency of a number of the attributes that are common across two or more of the data samples, wherein the number of the attributes does not exceed the length constraint associated with the attributes; and
define a given slice based, at least in part, on the attributes that are common across the two or more of the data samples and on the frequency of the number of common attributes;
determine, for each of the identified slices, a performance metric value based, at least in part, on the generated predictions and on the ground truth labels; and
display, via a user interface, the identified slices and corresponding performance metric values to a user.

18. The one or more non-transitory, computer-readable media of claim 17, wherein, to identify the slices, the program instructions further cause the one or more processors to:
receive another indication of a type of error that is to be used to identify the slices, wherein the type of error is a false positive error or a false negative error; and
for each of the slice identifications,
define the given slice based, at least in part, on:
the attributes that are common across the two or more of the data samples;
the frequency of the number of the common attributes; and
the common attributes being associated with the false positive error or the false negative error.

19. The one or more non-transitory, computer-readable media of claim 18, wherein to execute the slice finding model, the program instructions further cause the one or more processors to:
determine, for each of the identified slices, a relative risk ratio based, at least in part, on the generated predictions, on the ground truth labels, and on the type of error; and
additionally display, via the user interface, the identified slices for the user based, at least in part, on a hierarchy of the corresponding relative risk ratios.

20. The one or more non-transitory, computer-readable media of claim 17, wherein the program instructions further cause the one or more processors to:
provide the validation dataset, comprising the data samples and the attributes, to the machine learning model;
execute the machine learning model to generate the predictions associated with the data samples; and
generate the combined dataframe for the slice finding model.
